(19) United States
(12) Patent Application Publication
(10) Pub. No.: US 2015/0025991 A1
(43) Pub. Date: Jan. 22, 2015

(54) INTERNET BASED E-COMMERCE PLATFORM FOR USE BY CONSUMERS USING SOCIAL NETWORKS

(71) Applicant: Melissa Shaw, Rye Brook, NY (US)

(72) Inventor: MELISSA SHAW, Rye Brook, NY (US)

(73) Assignee: Team Deal LLC

(21) Appl. No.: 14/334,534

(22) Filed: Jul. 17, 2014

Related U.S. Application Data
(60) Provisional application No. 61/847,353, filed on Jul. 17, 2013.

(51) Int. Cl. G06Q 30/06; G06Q 50/00

(52) U.S. Cl. CPC G06Q 30/0605; G06Q 50/01
USPC 705/26.2

(57) ABSTRACT

A dynamic social-buying platform that provides a consumer with the necessary tools to leverage social media outlets (e.g. email, blogs, posting, etc.) in order to achieve specific levels of scale in assembling a specific group interested in a specific product or service, which in turn forces a retailer (who has previously committed to the platform) to furnish a given product or service at predetermined discount levels (which are directly correlated to the size of the group). In essence, a consumer forms a virtual group (for a specific product of interest), the consumer then recruits members to their virtual group via social media channels, and upon achieving certain levels of scale for that particular virtual group the consumer can force a retailer in the network to furnish the given product at a set discount level.

### BACKGROUND OF THE INVENTION

1. Field of the Invention

This invention generally relates to a system and method of consumer-initiated e-commerce for the purchase of goods and/or services at discounted prices and, more specifically, to an Internet-based e-commerce platform for use by consumers using social networks.

2. Description of the Prior Art

In U.S. Published Patent Application No. 2013/0018724 a system and method is described for providing a demand driven promotion system supporting social networking and searching.

The application describes a method of presenting (e.g., via the Internet) a consumer/buyer networking system to consumers. For example, various aspects provide a virtual forum in which consumers can aggregate their purchasing power to purchase consumer products (goods and/or services) in bulk at reduced bulk-rate prices. In other words, by aggregating demand for a given consumer product, a group can effectively drive the cost down for the given consumer product as compared to what the cost would be if the individuals in the group were acting alone.

The system may, for example, utilize such product-interest information to notify a user (e.g., on a web page, via text message, via email, via a mobile application, via social networking outlets such as Facebook™ or Twitter™, etc.) when a buyer group is being formed for purchasing a type of product that is potentially of interest to the user. For example, in an exemplary scenario in which a user has specified an interest in televisions, the system may notify the user of existing buyer groups and/or new buyer groups that have been formed for a television purchase.

For example, the user forming the group may specify that the system refrain from seeking a seller until a particular number of buyers have committed to the purchase. In an exemplary scenario, the user forming the buyer group may specify that the system wait until at least a thousand users join the group before the system presents the purchase offer to sellers (e.g., on a take-it-or-leave-it basis, soliciting counter-offers, etc.).

Traditional retail commerce has been driven by seller of goods and/or services who have used marketing techniques, promotions, advertising, etc. to try to create demand. However, with the advent of e-commerce consumers have now acquired the tools to take the initiative and drive sales by creating conditional demand of goods and/or services at preferential or discounted prices. By creating blocs of consumers the resulting groups can result in great purchasing demand and the resulting greater quantities can result in volume discounts that retailers are willing to entertain.

In U.S. Published Patent Application No. 2012/0179516 discount processing auction methods and systems are described where buyers pool their purchasing power in order to get more competitive offers from sellers. Instead of sellers directly bidding for the buyer's shopping lists, the sellers update their discount rules and a discount processing method processes the sellers' latest discount rules and presents the results to the buyers while the auction is active. Buyers dynamically form a group and invite others to join the group to increase their purchasing power and maximize the discounts. Customers can form a social network with other buyers to share wish-lists, shopping carts, and discount scenarios. Consumers who commit to buy a total number of items over a period of time increase their effective purchasing power across time. Sellers also group together to offer higher total discount on a combination of items to buyers.

Some embodiments provide a discount processing auction method where buyers pool their purchasing power in order to get more competitive offers from product manufacturers (producers), distributers/retailers, and shipping companies (collectively called sellers). Instead of sellers directly bidding for the buyer's shopping lists (as is the case in a traditional reverse auction) the sellers update their discount rules and a discount processing method processes their latest discount rules and presents the results to the buyers while the auction is active. Thus, the sellers indirectly bid (by updating their discount rules) on a pooled group of buyers.

Buying customers can dynamically form a group and invite others to join the group to increase their purchasing power across buyers and maximize the discounts. These customers can form a social network with friends (or other buyers) to share wish-lists, shopping carts, and discount scenarios. Consumers can commit to buy a total number of items over a period of time, thereby increasing their effective purchasing power across time. The buyer still buys the same items he/she would otherwise, but he/she tells the system in advance by committing to the purchases in order to receive wholesale discounts. A buyer's account can have multiple members who can access and modify the wish list of shopping items. This is useful for families and businesses.

A group of retailers/producers can group together to offer higher total discount on a “combination of items” in a buyer's wish-list or cart items. Grouping of sellers can be initiated by the sellers (e.g., sellers with complementary products can form seller groups) or can be analyzed and suggested by the system (e.g., by the statistics of items in all potential buyers' carts).

Some embodiments of the invention provide discount processing and management systems and methods where i) retailers, producers, and shippers separately or jointly enter their discount items and rules for single, wholesale, and group discounting scenarios, ii) buyers enter their cart items to receive highest discount offers from multiple retailers/producers or enter their wish-items with a price limit, iii) buying customers dynamically form a group and invite others to join the group to increase their purchasing power across buyers and maximize the discounts, iv) a single buyer receives wholesale discount by committing to purchase a large number of items over a period of time or by committing to purchase a total sum from the same retailer/producer over a period of time (increasing purchasing power across time); the system delivers higher discounts to individual buyers through a wholesale discounting mechanism where a buyer commits future purchases from a retailer or producer in exchange for additional discount, v) the discount processor analyzes group discounting rules by retailers/producers and identifies and optimizes group discounting scenarios by suggesting group discounts to buyers, vi) the system allows for sellers to form groups to offer more competitive overall discount on a buyers' total wish/shopping items, and vii) the system identifies seller grouping opportunities and suggests them to those sellers.

A replacement and suggestion engine is deployed to analyze customer's wish/cart items against the discounted items and rules by all retailers and producers. The replacement and suggestion engine then suggests replacement items to customers that may increase customers' overall single/wholesale/group discount. The replacement and suggestion engine is utilized in some embodiments for suggesting replacements based on other criterions than just final price such as suggesting healthier/organic replacement for a grocery item in exchange for higher discount percentage (and not necessarily lower final price). The sellers instruct the suggestion engine in some embodiments to replace a competitor's item in a buyer's list with their similar products in exchange for more aggressive discounting. Customers' purchasing history/trends/profiles (for both wish-lists and carts) are analyzed in some embodiments for suggesting replacement items based on these profiles, suggesting grouping with other customers for higher group discounts.

Some embodiments provide social networking capability where buyers interact with other buyers, share wish-lists and carts, share discount scenarios, initiate groups and expand existing groups, search for buyers with common purchasing profiles, post and review comments from other buyers, and others. The product in wish lists or carts can be travel/vacation packages, hotel rooms, airline tickets, car rentals, etc. Some embodiments utilize social networking to allow for buyers in a group (based on the fact that they have purchased a common item such as a car, travel package, etc.) to continue interactions after the purchase event. The buyers can use the system to continue to exchange product problems, comments, experiences, etc.

In U.S. Published Patent Application No. 2011/0087531, a computing apparatus includes: a data warehouse to store data associating a plurality of account identifiers with an offer having a predefined purchase requirement and an aggregated purchase requirement for a benefit; and a transaction handler configured to process a plurality of transactions. The transaction handler is further configured to determine whether each of the plurality of transactions satisfies a predefined purchase requirement, identify a set of transactions each satisfying the predefined purchase requirement, and determine whether the set of transactions satisfies an aggregated purchase requirement for the benefit. In one example, the transaction handler is configured to provide the benefit via statement credits when the set of transactions satisfies the aggregated purchase requirement.

In one embodiment, an advertising network is provided based on a transaction handler to present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers. In one embodiment, the transaction handler is further automated to process the advertisement fees charged to the advertisers, using the accounts of the advertisers, in response to the advertising activities.

In one embodiment, a social networking application is used to poll customer demands, e.g., via a web portal and/or advertisements, to obtain a volume discount for the customers. A transaction handler based system is configured to process synchronous or asynchronous payments for the volume discount. In one embodiment, the system is used as a platform for targeted/personalized advertisements.

In one embodiment, a social networking website, or other media channel, is used to aggregate demand for products and/or services. The providers of the products and/or services offer benefits, such as discounts, incentives, rebates, gifts, rewards, cash back, etc., based on the size of the aggregated demand. For example, an application may provide a way for people to connect online and create networks of people to aggregate demand and purchase merchant inventory in volume for discounts. Through the use of the application, merchants can capture new customers, leads, and data from pools of customers, while the customers get the benefit associated with the volume of purchases. A large number of transactions can make lower profit margins attractive to merchants. In one embodiment, the transaction handler based system is further configured to analyze the resulting data and behavior to provide the offers (e.g., volume discount or other offers) and provide targeted or personalized advertisements.

In one embodiment, the user tracker (113) determines certain characteristics of the user (101) to describe a type or group of users of which the user (101) is a member. The transaction profile of the group is used as the user specific profile (131). Examples of such characteristics include geographical location or neighborhood, types of online activities, specific online activities, or merchant propensity. In one embodiment, the groups are defined based on aggregate information (e.g., by time of day, or household), or segment (e.g., by cluster, propensity, demographics, cluster IDs, and/or factor values). In one embodiment, the groups are defined in part via one or more social networks. For example, a group may be defined based on social distances to one or more users on a social network website, interactions between users on a social network website, and/or common data in social network profiles of the users in the social network website.

In U.S. Published Patent Application No. US 2010/0179868 a method and system is disclosed for providing group discount pricing to individuals. A first customer orders a product from an online store and elects to defer delivery for a finite period of time. The online store provides the first customer with the ability to communicate with other persons to invite them to purchase a product from the online store. The online store assigns a purchase code which associates the other persons as members of the first customer's purchase group when any one of the others purchase a product and agrees to defer delivery for the finite period of time. The online store assigns a discount price to each product as a sale is completed and is added to the purchase group where the discount can be dynamically adjusted by the online store based on criteria that is determined by the online store.

The group-discount pricing model allows online retail stores to improve overall sales revenue by distributing the sales effort down to the individual online shopper, providing them with group-discount pricing as a performance incentive.

The online store accomplishes this by providing a software system, as part of their online store, that implements a mechanism whereby online customers can capitalize upon social networking and other Internet network channels to encourage other users (friends, relatives, acquaintances) to purchase items from the store, for a limited period of time, in exchange for discounted pricing for each of the products in the aggregate sale.

In addition, the software will present a list of all purchase groups on the website store front itself whose time period has not yet expired. The list will include information on the particular purchase group. For example, this may include the number of users currently participating in the purchase group, the current discount policy (see below), the current total discount percent, the time left before the purchase group expires. This is very much akin to an auction system that is typically implemented by auction sites in the sense that there is a list of “open bids” that users can participate in for a limited period. The difference here is that the price is not determined by the users but by the discount policy (see below).

The discount policy is dynamically adjustable by the store owner and can be tailored to match variables that are important to the store owner such as the cost of production or delivery, revenue numbers, cost of customer acquisition, or marketing, etc. A different discount policy can be generated based on a variable number of parameters of the store owner's choosing. It may include control variables such as different time period limits (e.g., 1 day, 5 days, 15 days); different “percent discount vs. time” function, a different “percent discount vs. no. of buyers” function, etc. And the discount policy may be offered in a variety of ways. For example, there may be a different discount policy for each product style, model, color or size group, season, etc. In its optimal configuration, users would be informed of the applicable discount pricing model prior to purchase.

In U.S. Published Patent Application No. US 2008/0082420 a method provides for group purchasing of a product or service, comprising determining, by a first customer, a product or service to purchase from a vendor, contacting, by the first customer, a second customer interested in purchasing the product or services, establishing a customer-defined group identity with the first and second customer being group members, purchasing the product or service from the vendor by the first and second customer using the group identity, and providing, by the vendor, a benefit that is at least one of a pre-purchase incentive and a post-purchase reward to the first and second customer based on the group identity. The sequencing of the method steps can be varied, and various incentive and communication arrangements can also be varied.

It is further known to offer a product on a web site wherein the price of the item drops when more people are willing to buy the product during a certain period of time.

As illustrated in FIG. 4, in a preferred embodiment of the present invention, individual consumers C 1-3 12 can dynamically form buying blocs B 1,2 and thereby avail themselves of various vendor incentives 24b for purchasing as a group that would not be available for the individual 12 alone. In the illustrated example, the vendor 10 markets to a first customer C 1. Customer C 1 then forwards the marketing to a second customer C 2, and the second customer forwards the marketing to a third customer C 3. A relationship is maintained between the customers by creating a buying ring B 1. All members of the buying ring benefit from the purchases of other members of that ring in that the members of the buying ring are able to avail themselves of the greater buying group vendor reward 24b instead of the lesser direct customer vendor reward 24a. A customer may be a member of more than one buying ring (e.g., C 2 is a member of buying rings B 1 and B 2).

Note that the group purchase would not have to be implemented as a simultaneous purchase. The “group” purchase could be performed within some defined time period. For example, for pizza purchases, the purchases could be considered as a “group” purchase if made within three hours of each other, whereas for electronic purchases from Decent Buy, the “group” purchases could be performed within a week, and automobile purchases could be performed within two months. Some mechanism would have to be used for identifying purchasers as belonging to a particular buying group. This could be implemented by assigning each group a unique identifier that is used in common by each member of the group when making the purchase.

A form of reminders could be further implemented. For example, if Bob has made a DVD purchase from Decent Buy, thereby starting a 24-hour window for those in his group to be included, he could program a reminder to others in his group at the 12-hour point to remind them of the group discount available. This reminder could further include an indication of the number of others who have made similar purchases or intend to make similar purchases as a part of the group. The reminder could be time based, or could be based on other criteria, such as group size or discount available.

For example, an alert could be sent out to others in the group when the group size for actual purchases (or possibly intended purchases, or some combination) reaches 50 people. Alternately, an alert could be sent out when the DVD price drops below $9.00 due to the number of purchasers in the group or actual purchases made. These criteria can be established either by the original purchaser, the vendor, or prospective friends in the buying group.

An alternative method suited to purchases that are not as time critical, such as the purchase of DVDs or electronics, would involve the initial user setting up all information necessary to generate a transaction with a chosen vendor, but then having that transaction put in a “hold” status. The transaction would not actually get created at that point, but a notification would then be sent to others wishing to participate in a shopping bloc for that vendor to let them know that there will be at least one other guaranteed purchase in their bloc if they place their own order within a pre-specified period of time.

In this scenario, the initial purchaser does not actually complete a transaction until the second shopper has also completed their transaction, with the second purchaser's transaction automatically generating a trigger to cause the initial transaction to be completed. This ensures for the first purchaser that they will have at least one more participant in their bloc before committing to a purchase.

The “hold” could also be extended until the expiration time of the bloc purchase in order to ensure that any discount could be determinatively applied to the present purchase itself for everyone in the bloc.

In U.S. Pat. No. 6,928,416 the virtual client discount pricing method adapts a variable pricing strategy based upon the aggregate utilization level of a group of separately managed accounts in the virtual client. As the funds vary, the participants in the group are provided with a rate or fee (or price) for a specified period, usually quarterly. The virtual client discount pricing methodology calculates an aggregate utilization rate for the fee. Pricing may be determined for multiple products; each product is preferably grouped separately and a price is determined on a product basis for the group. The system then computes the fee for each participant for each individual account based upon the aggregate product volume fee, the group discount rate, and an adjuster, and communicates the fee electronically and/or in written form to the participant.

The present invention utilizes a virtual client discount pricing method for assessing fees or prices to each of the accounts of the participants in the virtual client. The accounts are held by a plurality of participants in a virtual client, wherein each of the participants has at least one account. If the provider offers a plurality of products, then typically each account will be assigned to a product category.

A virtual client administrator, which may be a third party, may also create or assist in the creation of the virtual client, wherein the virtual client administrator may not be a participant in the virtual client. The virtual client may also be formed by participants utilizing the internet. For example, various individuals or entities may register to participate in a virtual client using the Internet. The virtual client administrator involved with creation of the virtual client may create or facilitate the Internet site to register the participants. The virtual client administrator may also negotiate with various organizations or entities to achieve a discounted rate for the participants in the virtual client, based on the total volume or aggregate utilization of the virtual client. The participants, in turn, receive a discounted rate or fee for goods or services using the discount available to the virtual client.

In U.S. Published Patent Application No. US 2004/0093276 affiliation groups are described as comprising a plurality of customers are provided, and discount information, such as discount rates, are established in advance based on the purchasing performance of the affiliation groups and the like, or discount rates or the like are varied according to variations in purchasing performance, and points are calculated. A point system wherein, a card or another information storage medium for storing customer information and point information is used, and when this is used, the information is read using an information reading means, a sum total of points is rerecorded according to a monetary purchase amount, and the data stored on the storage medium is tabulated and used for display or printing so that the information can be used as necessary in various sales services, and wherein customer information comprising information for individual single customers and information for individual affiliation groups, comprising a plurality of customers, and discount information, established for individual stores or products and for individual affiliation groups, is stored on a server system provided on a computer network connected to the information reading means, and when the information is read by the information reading means, points are calculated according to discount information established for individual stores or products and individual affiliation groups.

Furthermore, systems are put in place, such as those wherein the price is lowered in the case of large quantity purchases of specific products or of group-buying by large numbers of consumers.

However, the described system/method takes the form of a group purchase or common purchase at a specific store. It consists of giving a benefit to a group in accordance with the purchases of a common purchasing group, and thus discounts and the like are not made available for purchases at a plurality of outlets or enterprises. Moreover, the benefit is only given to the group for group purchases, and discounts are not awarded to the individual customers who make up the group according to their actual purchases, nor does it support setups wherein there are further subgroups of group members. Stated simply, giving benefits to a group for group purchases is simply replacing the individual with the group in a simple discount scheme that amounts to the same thing as an ordinary discount to an individual.

In order to solve the aforementioned problems, there is provided a point system wherein, by providing an affiliation group comprising a plurality of customers and establishing discount information that is set for each affiliation group, discount information, such as discount rates, can be established in advance based on the purchasing performance of the affiliation group, or the discount rates can be further changed in accordance with changes in purchasing performance, allowing points to be calculated according to discount information.

In terms of the storage method for the table for customer affiliation groups, a plurality of customer affiliation groups can be established and stored, so that a given customer may be affiliated with a plurality of groups. A plurality of group databases are provided so that discounts can be applied based on the characteristics of the various groups. Furthermore, the discount rates applied to the various groups can be applied in combination, so as to be a benefit in the discount rates. For example, a first group is a group related by introduction; the customers who are related by introduction form a group, and a discount rate is applied according to the number of people and the sales totals. This is an effective group for promoting introduction on the part of customers. A second group is a group in which customers having the same sales figures are gathered; this is established as a separate group from the group related by introduction; in this affiliation group, the discount rate varies according to the rank of their sales total within the group. If their rank rises to a specific level, their affiliation can be changed to a group having a higher sales total. The third group is a category-based group; for example, this can be established so that the discount rate on food products is increased for customers who purchase large amounts of food products, and the discount rate for clothes is increased for customers who purchase large quantities of clothes.

Data, such as the discount rate, is established according to the size and the purchasing performance of affiliation groups, which are formed by such means as recruiting of members to groups having high discount rates by stores and the like; the discount rate varies and is set dynamically, according to variations in purchasing performance. Furthermore, it is possible to form subgroups within the groups. Furthermore, people who have become members can form new groups.

On website “http://www.deal.com.sg/how_it_works” once the minimum number of buyers for a certain DEAL is reached, the DEAL is “on”. The minimum number has been reached when it says “The DEAL is ON!” below the counter. Immediately after a purchase an email is sent with an electronic voucher. The purchaser can then print that voucher out for redemption at the merchant. Since a large number of buyers are aggregated for each merchant, discounts can be passed on to customers.

### SUMMARY OF THE INVENTION

A dynamic social-buying platform provides a consumer with the necessary tools to leverage social media outlets (e.g. email, blogs, posting, etc.) in order to achieve specific levels of scale in assembling a specific group interested in a specific product or service, which in turn forces a retailer (who has previously committed to the platform) to furnish a given product or service at predetermined discount levels (which are directly correlated to the size of the group).

In essence, a consumer forms a virtual group (for a specific product of interest), the consumer then recruits members to their virtual group via social media channels, and upon achieving certain levels of scale for that particular virtual group the consumer can force a retailer in the network to furnish the given product at a set discount level.

The key elements to this unique model include (1) social media used for social buying, (2) virtual groups created solely for a specific product of interest, (3) size of group dictates size of discount for group, for example capped at 200 people and capped at 50% off, (4) retailers pre-register and contractually agree to provide specific discounts on certain products based on the size of the group. However, the invention does not require or contemplate any specific limits on the number of people and/or maximum discounts as these may be modified to fit any specific situations or requirements.

The business model is akin to that of the “puts” and “calls” in the stock market applies it in conjunction with social media, and effectively creates a new form of “social-buying”.

In essence, the model creates a platform where “Retailers” sign up for “calls” that remain open, and “Consumers” form virtual groups that trigger the “puts” once they achieve scale—and therefore force the Retailer to furnish the goods at the pre-negotiated discount rates.

In the stock market, a “put” gives its holder the right to sell a specific number of shares of a specific stock at a specific price—known as the exercise price (or “strike price”)—by a certain date. In accordance with the model of the invention, a “put” obligates the retailer to sell a specific number of units of a specific product at a specific price—with no end date.

In the stock market, a “call” gives its holder the right to buy a certain number of shares of a stock at a specific strike price by a certain date. In the subject model, a “call” gives the consumer (or virtual group) the right to buy a certain number of units of a specific product at a specific price if certain volumes are achieved.

In accordance with the invention an individual forms a virtual group for a specific product or service of interest. The group size directly dictates the extent of the of discount offered. Group members must deposit a predetermined percentage of the then SRP to secure their position in the group.

The system is structured to provide a ladder system for the time to assemble a family. In other words, the initial group has, for example, 30 days to form, and if it crosses the minimum threshold (25 members), then the 30 day clock can start over to provide ample time to get to the next threshold (50 members), and so on.

### BRIEF DESCRIPTION OF THE DRAWINGS

The accompanying drawings, which are incorporated in and form a part of the specification, illustrate preferred embodiments of the present invention, and together with the description, serve to explain the principles of the invention, in which:

FIGS. 1a and 1b are a diagrammatic overview of an online discount processing auction system that they can be used to practice the invention;

FIG. 2 is a flowchart illustrating the logic of the software implemented by the system shown on FIGS. 1a and 1b used by an individual to form a group to purchase a product or service;

FIG. 3 is similar to FIG. 2 but shows how deposits by members of the group are handled or reprocessed;

FIG. 4 is similar to FIGS. 2-3 but illustrates how a system clock resets upon reaching a next discount tier size;

FIG. 5 similar to FIGS. 2-4 but illustrates how a system clock resets upon reaching a next tier size and a family or group of votes to close a sale;

FIG. 6 is similar to FIG. 5 but illustrates how a system clock resets upon reaching a next tier size, with the head of a family or group being provided with the option to close the sale; and

FIG. 7 is similar to FIG. 6 but illustrates how the closing of the sale can also be implemented by or by a function of changes in buying rates or entry of new members or customers joining the group.

### DETAILED DESCRIPTION OF THE PREFERRED EMBODIMENT

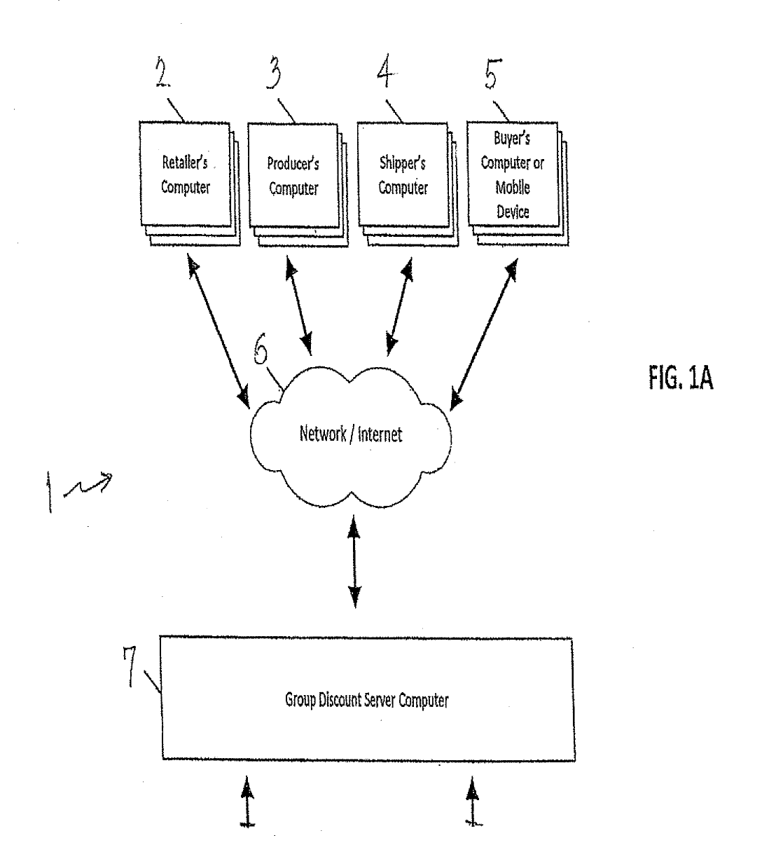

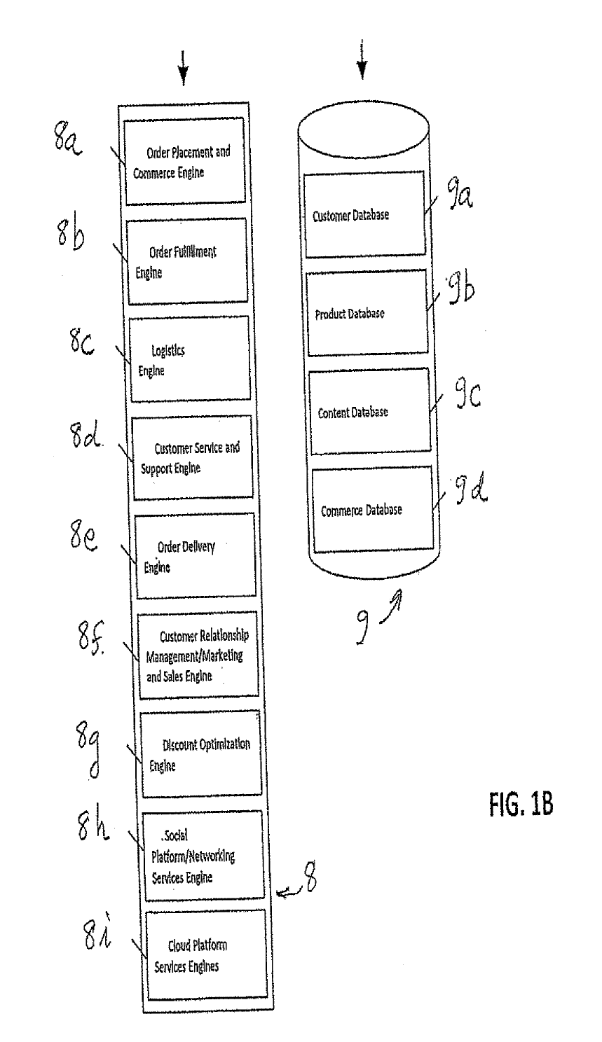

Referring now specifically to the drawings, in which identical or similar parts will be identified by the same reference numerals throughout, and first referring to FIGS. 1a and 1b a system 1 is illustrated for implementing the Internet-based e-commerce platform for use by consumers using social networks in accordance with the present invention.

The system 1 includes a plurality of distributed retailer's computer terminals 2, a plurality of distributed producer's computer terminals 3, a plurality of distributed shipper's computer terminals 4 and a plurality of distributed buyer's computer terminals or mobile devices 5. All the computer terminals 2-5 are provided with means for accessing a network/Internet 6 and a group discount server computer 7 that hosts a website for implementing invention. For purpose of this description the website will be referred to as GetYourTeamAGreatDeal.com.

The group discount server computer 7 is programmed with software 8 that includes a number of applications or modules 8a-8i. More specifically, application or module 8a is an order placement and commerce engine; 8b is an order fulfillment engine; 8c is a logistics engine; 8d is a customer service and support engine; 8e is an order delivery engine; 8f is a customer relationship management/marketing and sales engine; 8g is a discount optimization engine; 8h is a social platform/networking services engine and 8i is a cloud platform services engine.

The group discount server computer 7 also includes a number of databases 9, including a customer database 9a; a product database 9b; a content database 9c and a commerce database 9d.

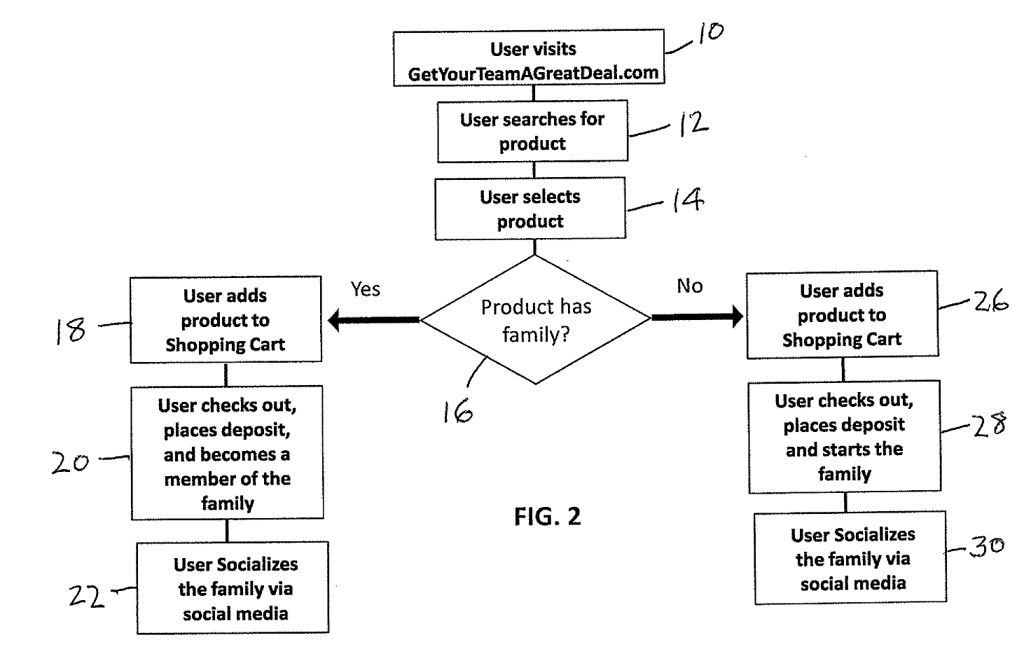

FIG. 1 conceptually illustrates an overview of an online discount processing auction system in some embodiments of the invention. The discount processing auction server 7 (i) analyzes the data in the databases of buyers, retailers, producers, and shippers, (ii) runs the applications to be described in connection to FIGS. 2-7.

Although the system and the associated databases and modules are described by using retailers, producers, and shippers as examples of sellers, the term seller refers to any other seller such as manufacturers, growers, assemblers, wholesalers, middlepersons, dealers, etc., in the supply chain. Similarly, the term buyer not only refers to retail buyers, it also refers to any entity that purchases merchandise and services throughout the supply chain. For instance, a wholesaler might act as buyer when dealing with manufacturers but act as a seller when dealing with retailers.

This specification refers to single, wholesale, buyer-group, and seller-group scenarios and discount rules. A single scenario refers to the case where there is a single buyer looking for items to buy. A wholesale scenario refers to a single buyer who is interested in or commits to buying a large number of items or large sum amount over a specific time period. A buyer-group scenario refers to the case where there is a group of buyers looking for common items or a large dollar amount to buy. A seller-group scenario refers to the case where a group of sellers offer a combined discount on multiple items in a buyer's or buyers' list.

The term discount processor refers to combination of hardware processors, servers, and software that manages/analyzes/processes all available bidding/discount rules/policies. The term auction site refers to the online interface used by the discount processor to interface with buyers and seller.

A. Databases and Tables

FIG. 1b shows several databases (or tables) 9a-9d. The databases contain information about buyers, sellers, and products in some embodiments of the invention.

Retailer/Producer/Shipper Database

The “Retailer/Producer/Shipper” database 9d includes information about all registered retailers, producers, and shippers. This includes unique database IDs for each, their login and authentication information, their locations and telephone numbers, etc.

Buyer Database

The “Buyer” Database” 9a includes information about all registered customers who are potential buyers. This includes unique database IDs for each buyer, their login and authentication information, and optional information such as shipping address, telephone numbers, etc. The “Buyer's Location” database 9a can also include the buyer location. The buyer can provide static locations for home/work, or the buyer can provide dynamic locations using positioning technologies (GPS, WiFi, etc.). The buyer's location is then used to provide location dependent offers, maps, and directions to stores.

Product Category Database

The “Product” database 9b includes categories for products. The categories are used to help users find their wanted products (e.g., Cameras, Dairy, etc.). The “Product” database” 140 also includes actual products from a particular producer. Each category has one or more products inside it.

B. Application Modules

FIG. 1b also shows several application modules (or engine programs) in some embodiments of the invention.

Discount Optimization Module

Engine 8g is a discount optimization module that handles single or group buyers and processes time and location dependent rules. This engine analyzes the data in the products, customers, retailers, producers, and shippers databases, calculates top discount values and scenarios, and presents them to a customer or group of customers (in group discount scenarios). This engine utilizes other functionalities and engines within the system to perform its tasks.

Discount Management and Delivery Module

Order fulfillment and logistics modules 8b, 8c process and deliver products and order information to a customer or a group of customers. These engines can also handle discount sources (retailer, producer, shipper), and discount types (coupon, e-Coupon, rebate, gift-card, cash-back, credit, direct cash, rewards).

Grouping Module

The order placement and commerce engine 8a receives, monitors and registers incoming orders. Engine 8a is a grouping module that helps form groups of customers in order to qualify for larger wholesale/group discounts. This grouping is either based on the system analyzing the purchasing profiles of customers or is initiated at the request of customers. This grouping is initiated by buyers or purchasers.

Social Networking Module

Engine 8h is a social networking module that helps with implementing a social networking capability between registered customers. This is implemented either on top of an existing social network (e.g., Facebook) or through a proprietary social network. The customers use this engine to share their carts, wish-lists, successful discount scenarios, and purchasing profiles with other customers. The customers utilize this network to identify and form groups to apply for higher group discounts.

Authentication Module

The engines 8a and 8b can also use information in the “Buyer's Database” to authenticate a buyer and allow them to use the system.

Referring to FIGS. 2-7 the software architecture and logic shown for the software application in FIG. 1b, and particularly modules 8a and 8g will be described in connection with the flow charts shown. The remaining modules are routine and would be well known to those skilled in the art. For example, reference is made to U.S. Published Patent Application No. US 2012/0179516, which is incorporated as if fully set forth herein.

Referring to FIG. 2, the procedure commences when a user, purchaser or buyer accesses, via the Internet 6, the group discount server computer 7 by way of one of the distributed computer terminals 5 and logging in a website, at 10, designated as “GetYourTeamAGreatDeal.com”. Once logged in, the user searches for a specific product or service, at 12, and the website returns search results indicating whether the product or service searched is available or can be acquired through the website. The user selects the desired product or service, at 14, from the search results. The system initiates a search, at 16, to determine if the product or service is already the subject of a family or purchasing group that has been previously created. If the system determines that a previous family or group has been initiated for the same product or service the system adds the desired product or service to a shopping cart, at 18. At that point, the user can “check out” and place a deposit for the product or service, at 20, and become a member of the family or buying group. A feature of the invention is that the user who has just become a member of the family can then make use of social media to socialize or publicize the group or family and that the selected product or service can be acquired by others who may wish to join the same group or family, at 22. The greater the size of the group typically the greater the discount level or tier that the group can realize through volume or bulk purchase.

If the system, however, determines that no such a prior group or family has yet been formed or created for the specific product or service the user can still add the product or service to the shopping cart, at 26. The user can then check out, at 28, place a deposit towards the product or service to be purchased and start a new group or family, at 28. Again, a user can then make use of social media to publicize the group or family and that the selected product or service can be acquired by others who may wish to join the same group or family, at 30.

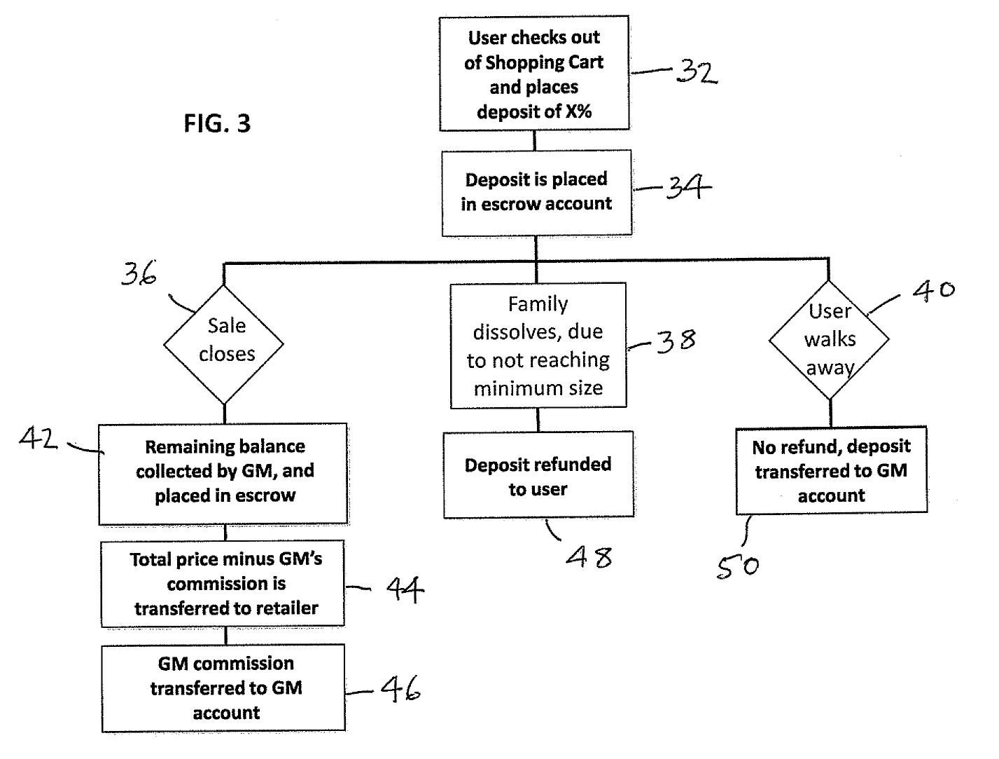

Referring to FIG. 3, the routine or subroutine for handling deposits is illustrated. Once the user checks out of the shopping cart the user places a deposit of X %, at 32, where x is established by the system 1 and may vary from product-to-product or for different categories of goods/services or may be a function of the base price or MSRP. The deposit is placed in escrow bank account, at 34, and the deposit, together with other funds deposited in the escrow account are held in the account until it is time to disperse the funds to a seller of the product or service.

After a group or family has been formed and at least one deposit placed into the escrow account the system determines whether the sale closes, the family or group is dissolved due to inactivity or failure to reach the minimum size group or the user walks away. If the system determines that a critical mass has been reached and the group or family has grown to a size sufficient to at least provide a predetermined or desired price discount or a first discount tier has been reached for the selected product or service the sale can be closed, at 36. If the sale closes, the remaining balance is collected by the website and placed in an escrow bank account, at 42. The total price of the product minus websites commission is transferred, at 44, to the retailer selling the product or service from the escrow account. The website's commission for operating the website and making the purchase and discounted price possible is transferred to the website's bank account to, at 46.

In the event that the family or group does not reach the minimum size required for even a first level of discount in the purchase price of a product or service the group or family is dissolved, at 38 and the deposits are refunded to the users who had joined the family or group and made deposits, at 48. However, if the sale does not close, as at 36, or does not dissolve, as at 38, and a user walks away after having made a commitment and given a deposit, the user loses the refund and the deposits are transferred to the account of the website, at 50.

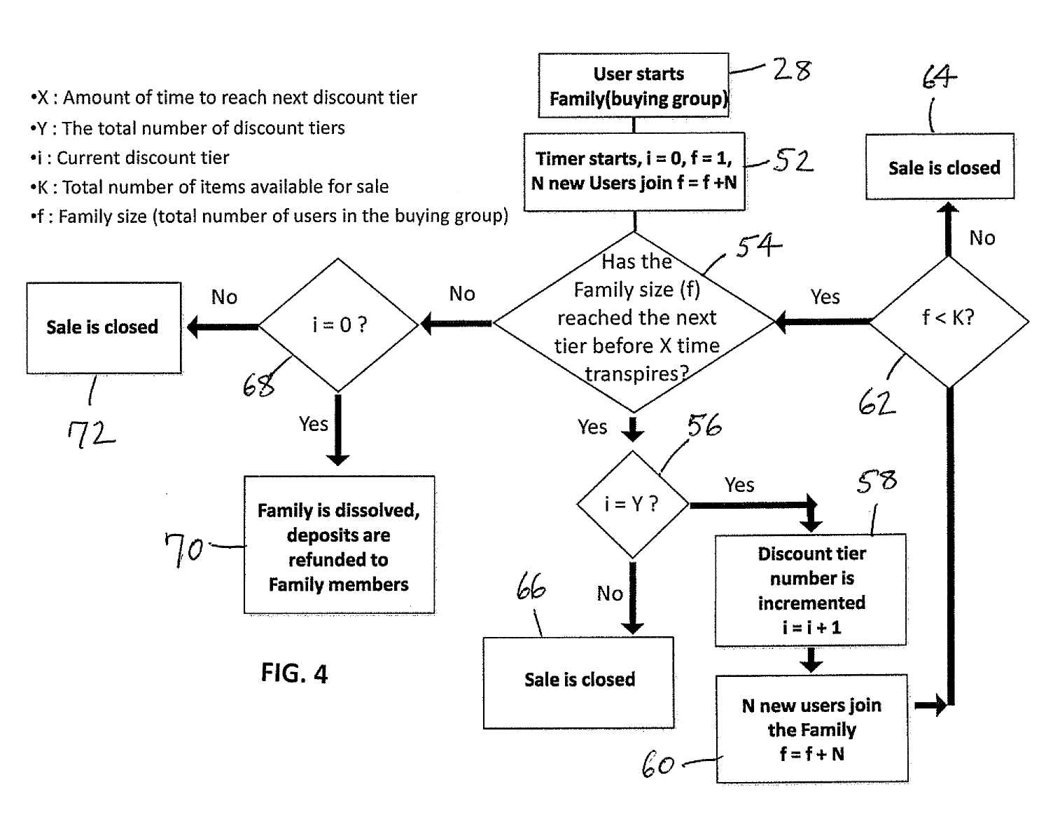

FIG. 4 illustrates how the system clock resets upon reaching a next discount tier size. For purposes of this description the following definitions or keys will apply:

N: Users that have joined the family or buying group;

x: Amount of time to reach next discount tier;

Y: The total number of discount tiers;

i: Current discount tier,

K: Total number of items available for sale;

f: Family size (total number of users in the buying group);

b: buying rate during time x;

I: % of b at which to close sale.

Thus, once a user starts a group or family (buying group), at 28, a timer or clock starts, with initial settings i=0 and f=1 to designate that the initial discount tier is 0 or no discount is yet applicable and the initial family or group size is 1 member. When new users N join the group f=f+N, at 52. The system then determines whether the group or family size f has reached the next tier before X time expires, at 54. If the system determines that the current discount tier i is equal to the total number of discount tiers Y, at 56, the discount tier number is incremented (i=i+1), at 58, and new members can join the family, at 60, to increase the family size f=f+N.

At 62 the system determines if f<K or is the total number of users in the family less than the total number of items available for sale. If the answer is “no” the sale is closed, at 64. However, in the total number of users is less than the total number of items available for sale the system returns to step 54 to determine if the family size f has yet reached the next tier before X time transpires. The aforementioned loop continues until the family size F has failed to reach the next tier before X time transpires or f=K where the family size equals the number of items available for sale. Thus, if the answer is “no” the system queries if the current discount tier is equal to 0, at 68. If the answer is “yes” the family is dissolved and the deposits are refunded to family members, at 70. However, if the current discount tier is not equal to zero or at least one discount tier has been reached, although the next family size tier has not increased before X time transpires, the sale is closed, at 72 at their prevailing discount tier.

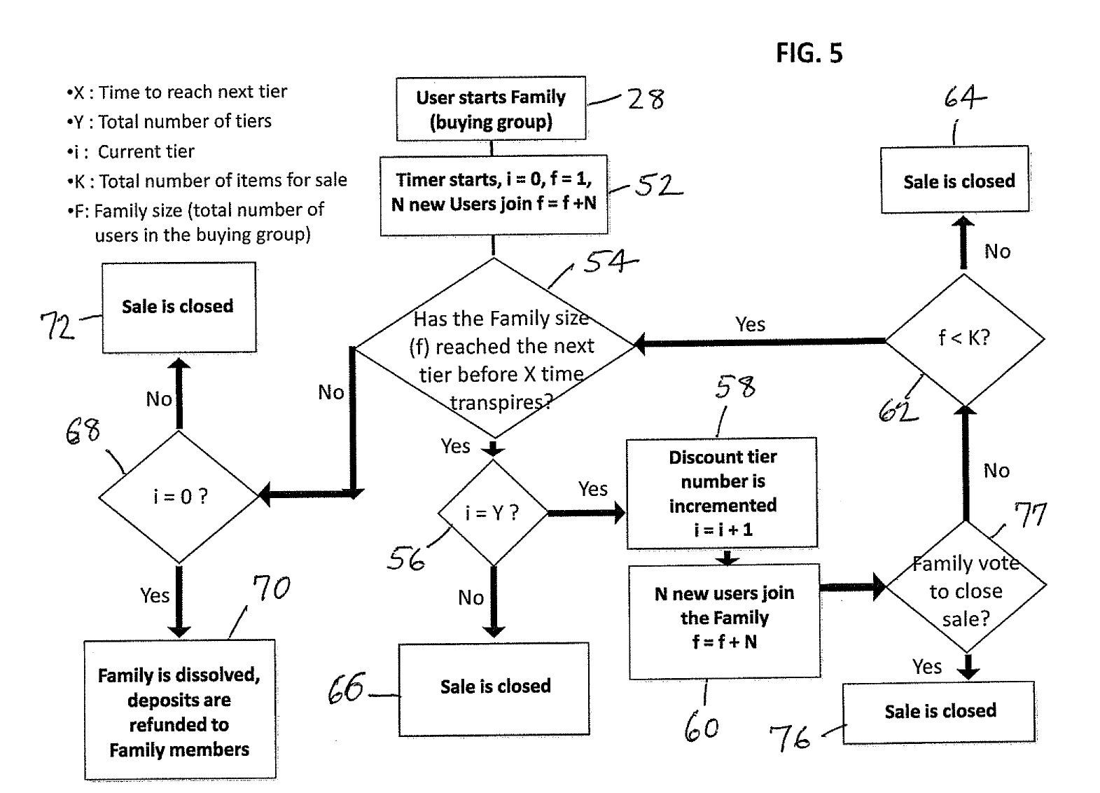

FIG. 5 is similar to FIG. 4 but shows an additional sub-routine for resetting the clock when the next tier size is reached. Thus, when new users join the family (f=f+N), at 60, the family or group is given the option to vote on whether to close the sale, at 77. If the answer is yes the sale is closed, at 76. However, if the group votes not to close the sale then the subroutine continues as described in connection with FIG. 4 to determine, at 62, whether the total number of users in the family is less than the total number of items available for sale.

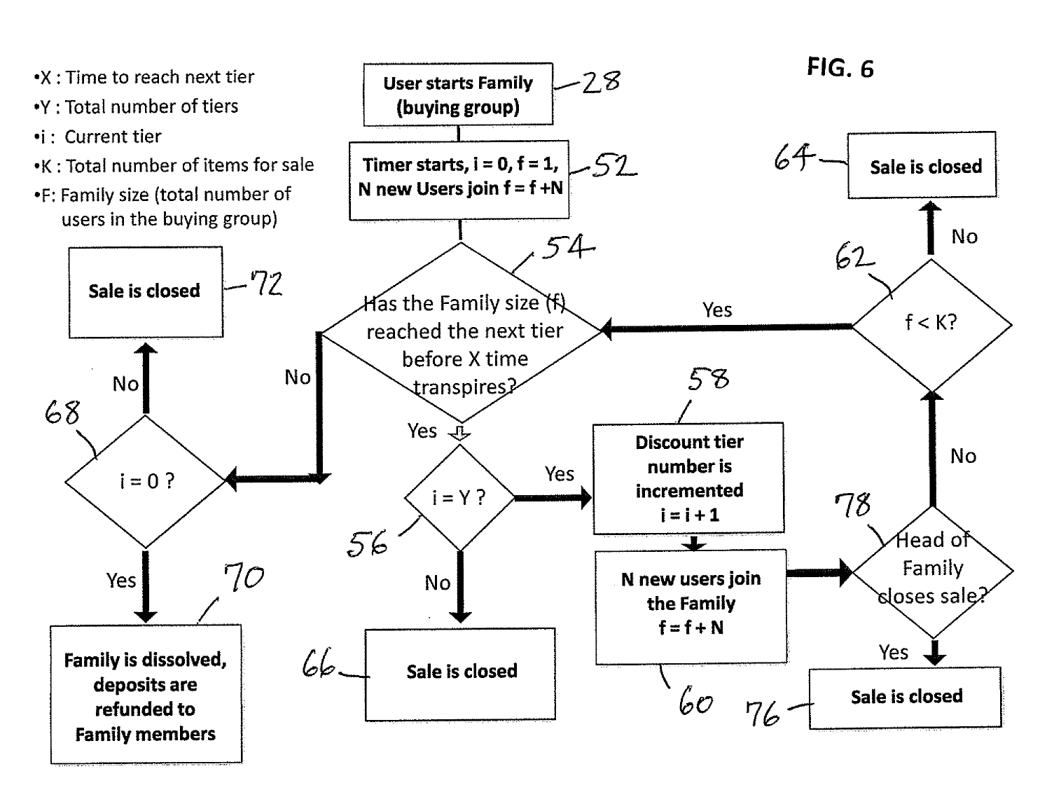

In FIG. 6, a similar sub-routine is illustrated as in FIG. 5 with the exception that the clock of the system can be reset upon reaching of the next tier size and the “head of the family” or group is given the option to close the sale, at 78. Thus, if the rate at which new users joining the family decreases to a predetermined slow or creep rate and the person that initiated the group or family determines, based on any one of a number of different reasons, that it is time to close the sale the head of the family can be given that option, assuming that all of the other conditions have been met to so, and as long as the family does not become dissolved.

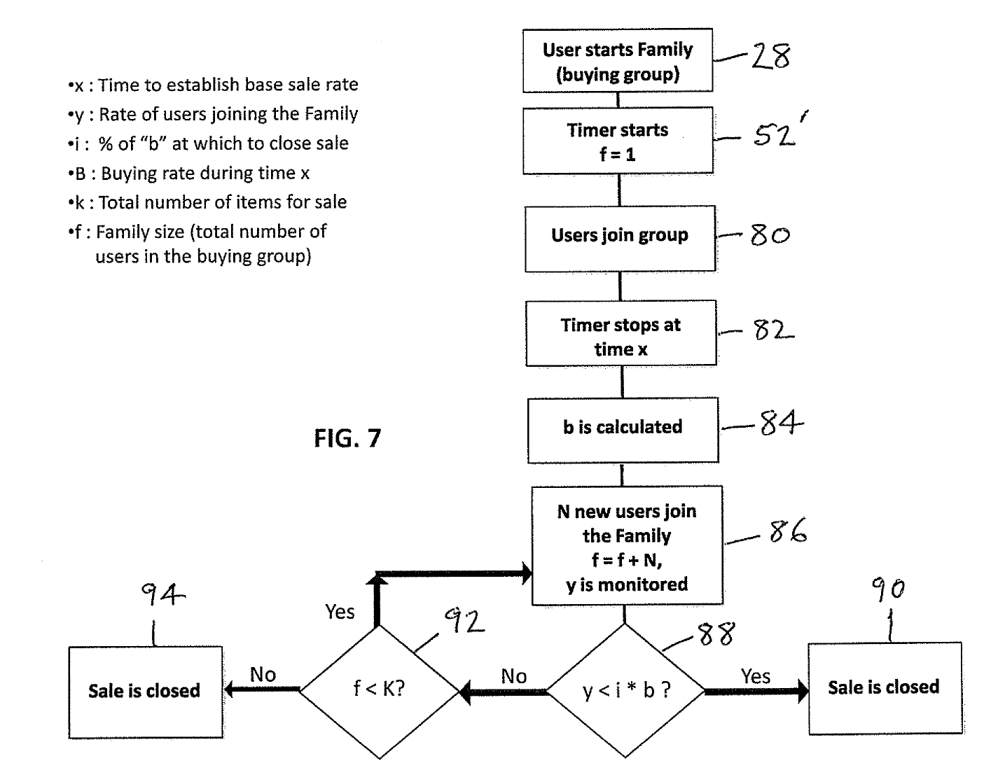

In addition to closing the sale as a result of a group vote, as in FIG. 5, or as a result of the head of the group deciding to close, as in FIG. 6, the program can also, in accordance with another embodiment or modality of the invention, be closed as a result of a change in the buying rate or the rate at which new members come into or try to join the group. Thus, referring to FIG. 7, a buying group or family is started, at 28, as previously described. A timer starts with (f=1), at 52′. Users are allowed to join the group, at 80, and a system timer stops at time x to establish a base sale rate. The system calculates the buying rate b during a time interval x, at 84. New users can commit to join the family or group (f=f+N) and the rate of users joining the group or family y is monitored, at 86.

At any given time, the system can determine, at 88, if the rate of users joining the family y is less than the product of the predetermined percentage of the buying rate at which to close the sale and the buying rate b during the time x (y<I*b). If the answer is yes, the sale is closed, at 90. However, if the answer is “no” and the total number of users in the family is less than the total number of items available for sale, at 92, additional new users are permitted to join the group, at 86. If the total number of users in the group is equal to or greater than the number of items available for sale the sale is closed, at 94.

Therefore, a sale can be closed either by reaching an equilibrium between the number of users in the family and the number of items available-for-sale or the number of new users being added is at a rate that is too low to continue bringing in new users as this may unreasonably enlarge the time for closure. Clearly, the percentage of the buying rate during time x can be selected by the website or, in some instances, the initiator of the group may be given that option.

While the invention has been described in detail and with reference to specific examples and the embodiments thereof, it will be apparent to one skilled in the art that various changes and modifications can be made therein without departing from the spirit and scope thereof.

What is claimed:

1. A method of purchasing products using e-commerce comprising the steps of
a. providing a user interface to purchasers with a dynamic social-buying platform to leverage social media outlets;
b. providing a retailer interface to enable retailers to offer and commit a product or service at a set or predetermined price or discount when a predetermined number of purchasers have committed to purchase a predetermined number of said product or service within a predetermined time frame;
c. forming a virtual consumer purchasing group by a first purchaser interested in purchasing said product or service;
d. using said social-buying platform on said user interface by at least said first purchaser to locate additional potential purchasers interested in committing to purchasing said product or service;
e. obligating a retailer to sell said predetermined number of said product or service to said predetermined number of purchasers when said group of committed purchasers is formed within said predetermined time frame; and
f. closing said group either when said group of predetermined number of purchasers committed to purchase said predetermined products or services has been reached or when said predetermined number of purchasers has not been reached within said predetermined time frame.

2. A system for purchasing products using e-commerce comprising a server for hosting a website including:
a. a user interface module to purchasers for providing a dynamic social-buying platform to leverage social media outlets;
b. a retailer interface module accessible to retailer computers to enable retailers to offer and commit a product or service at a set or predetermined price or discount when a predetermined number of purchasers have committed to purchase a predetermined number of said product or service within a predetermined time frame;
c. said user interface module being accessible to purchaser computer for forming a virtual consumer purchasing group by a first purchaser interested in purchasing said product or service;
d. a module on said server for enabling use of said social-buying platform on said user interface by at least said first purchaser to locate additional potential purchasers interested in committing to purchasing said product or service;
e. a module for obligating a retailer to sell said predetermined number of said product or service to said predetermined number of purchasers when said group of committed purchasers is formed within said predetermined time frame; and
f. means for closing said group either when said groups of predetermined number of purchasers committed to purchase said predetermined products or services has been reached or when said predetermined number of purchasers has not been reached within said predetermined time frame.
